(19) United States
(12) Patent Application Publication
(10) Pub. No.: US 2016/0032734 A1
(43) Pub. Date: Feb. 4, 2016

(54) FAN FOR A MULTI-FLOW TURBOSHAFT ENGINE, AND TURBOSHAFT ENGINE EQUIPPED WITH SUCH A FAN

(71) Applicant: SNECMA, Paris (FR)

(72) Inventors: Michaël Delapierre, Moissy-Cramayel (FR); Patrick Jean-Louis Reghezza, Moissy-Cramayel (FR)

(73) Assignee: SNECMA, Paris (FR)

(21) Appl. No.: 14/776,300

(22) PCT Filed: Mar. 4, 2014
(86) PCT No.: PCT/FR2014/050472

§ 371 Date: Sep. 14, 2015

(30) Foreign Application Priority Data
Mar. 15, 2013 (FR) 1352318

(51) Int. Cl. F01D 5/26; F01D 5/30; F01D 1/06; F01D 9/04; F02K 3/00; F02K 1/00

(52) U.S. Cl. CPC F01D 5/26; F02K 3/00; F02K 1/00; F01D 1/06; F01D 9/041; F01D 5/3007; F05D 2220/34; F05D 2260/96; F05D 2240/35

(57) ABSTRACT

The fan comprises a fan disk able to be rotationally driven about a longitudinal axis and provided at the periphery with radial blades each comprising a root slideably engaged in a groove of the disk and, on the outside thereof, a vane, platforms surrounding the disk being interposed between the radial blades. Advantageously, the fan additionally comprises shock-absorbing wedges which are arranged tangentially at the exterior periphery of said disk underneath the platforms and between two roots of adjacent radial blades, each wedge being in tangential contact with the two adjacent blades.

The present invention relates to a fan for a multi-flow turboshaft engine, in particular a fan for a bypass turbojet engine of an aircraft.

As a reminder, a twin-spool turbojet engine comprises, from upstream to downstream in the gas flow direction, a fan in a casing, a compressor, a combustion chamber, a turbine and an exhaust nozzle. The two spools, a low-pressure spool and a high-pressure spool, rotate independently of one another and are coaxial with the longitudinal axis of the turbojet engine. A compressor is understood to be a low-pressure compressor upstream of a high-pressure compressor, and a turbine is understood to be a high-pressure turbine upstream of a low-pressure turbine. In the description, internal or external or inner or outer are to be understood as being radially internal or external or inner or outer with respect to the engine in relation to the longitudinal axis thereof.

The fan is located upstream of the low-pressure compressor in front of the low-pressure spool, and receives all the air flow which enters the engine, inside a nacelle.

Structurally, the fan comprises a fan disc which is provided, on the outer periphery thereof, with radial blades and which is internally connected, during operation of the turbojet engine, to the low-pressure drive shaft of the corresponding turbine-compressor assembly. From the outside towards the inside, each radial blade comprises a vane located in the air flow, and a root having a heel which is arranged so as to be inserted, in the standard manner, into an axial recess or groove made in the outer periphery of the fan disc. Platforms, from which the vanes project outwards, are inserted between said vanes and laterally extend the conical cowl or nose upstream of the fan as far as the drum or rotor of the low-pressure compressor.

It is known that, during operation of the turbojet engine (in flying mode or when taxiing), when the fan is being rotated by the low-pressure shaft, the blades are subjected to vibrations which accelerate the damage thereto and reduce their service life. To limit this effect, it is also known to use damping devices positioned in receiving slots made below the platforms of the blades, as taught, for example, in particular by FR-2923557 of the applicant.

Moreover, during maintenance work, wear has been observed between the fan and the low-pressure compressor associated therewith. In particular, this wear is located at the opposing contact regions between the upstream flange of the compressor drum and the roots of the blades of the fan disc.

This wear originates from the rear faces of the blade roots rubbing against the front face of the upstream flange when the fan is operating in windmilling mode on the ground, that is when the fan disc is not being driven by the low-pressure drive shaft.

Indeed, particularly for assembly reasons, the blades are inserted, by the heels in which the roots thereof end, into the axial receiving recesses in the disc with a certain degree of angular movement (from 1 to 2°) in the radial plane. When the fan is not being driven by the shaft and is thus freely rotating and made to windmill by the air entering said fan, the blades also move freely in their respective axial recesses with each rotation of the fan, and do so in particular when the platforms are attached to the blades and thus not integral therewith.

As a result of the air drawn in and of the axial gliding or sliding of the blades relative to the recesses towards the compressor, bearing contact is produced between the rear faces of the roots of the blades and the front face of the upstream flange of the compressor drum. This pressing contact causes rubbing and, since this contact is cyclical and can be of a significant strength, wear arises between the parts (blades, drum, etc.) and this can reach a particular depth during use and, as a result, can impair the mechanical strength and affect the service life of the parts in question. In addition, EP-0081416 discloses a device for damping the blades of a pneumatic fan by means of inflatable shims.

The object of the present invention is to overcome these drawbacks and provide a simple, effective solution to this problem of wear between the blades of the fan and the flange upstream of the compressor drum.

In this regard, the present invention relates to a fan for a multi-flow turboshaft engine, comprising a fan disc which is capable of being rotated about a longitudinal axis and which is provided, on the outer periphery thereof, with radial blades which each comprise a root which is slidably inserted into a groove in the disc, and, on the outside of said fan, a vane, platforms which surround the disc by being placed between the radial blades, and damping shims which are provided in respective cavities defined by the outer surface of the disc, the roots of the blades and the platforms.

According to the invention, a fan of this type is characterised in that the damping shims are arranged tangentially on the outer periphery of said disc and close to the outer surface thereof, between two roots of adjacent radial blades, are elastically deformable, and have a tangential width which is at least equal to the distance separating two adjacent blades on the periphery of the disc, such that each shim is in tangential contact, by means of compression, with the two adjacent blades, a fixed support being provided in each cavity receiving a shim in order to radially hold said shim in position.

By arranging the damping shims tangentially between the blades, the angular movement of said blades is thus limited or eliminated, such that when the fan is windmilling, the blades substantially remain in position in the grooves, which eliminates or at least significantly reduces the relative gliding of the blades relative to the upstream flange of the drum which results in the appearance and development of wear. Since the shims are always slightly elastically deformed as a result of compression between two successive blades in order for said shims to be held in position, the angular movement of said blades which causes these problems is thus absorbed directly by the shims, without further modifying the design of either the parts (disc and blades) of the fan or the drum. In this way, shims of this type can be adapted to all types of engines and can become “universal” shims.

In addition, it should be noted that the object is not to reduce the contact (result) between the blades and the drum when the fan is windmilling, but rather to avoid the angular movement (cause) of the blades within their recesses by rendering them immobile tangentially.

It should also be noted that the conventional devices for damping vibrations in fan blades, as they are used when the fan is being rotated by the turbine/low-pressure compressor shaft, do not address the problems set out above when the fan is windmilling, and are thus completely ineffective in this regard. On the other hand, the tangential damping shims of the invention advantageously help to reduce the vibration levels in the vanes of the blades by providing additional damping during operating phases of the turboshaft engine, when the drive shaft is coupled to the fan.

Preferably, the damping shims are provided between all the blades of the disc.

For example, the elastically deformable damping shims are made of a synthetic or natural polymer material, such as an elastomer, and the hardness thereof is within a range of from 60 to 90 Shore.

In addition, each support is fixed on one side by a first fixing member which connects the disc to a connecting flange of a compressor drum, and on the other side by a second fixing member which connects the disc to the corresponding platform.

In particular, each support is stirrup-shaped in the form of an upside down U, between the legs of which the damping shim is arranged and which is inserted between two external radial tabs on the disc, which interact with a central radial lug on the corresponding platform and with the flange, respectively, said damping shim projecting tangentially from said U-shaped support in order to be in contact with the two roots of adjacent blades.

Preferably, each elastically deformable damping shim has an oblong, elliptical or similar shape, having rounded opposite side edges which come into contact, as a result of compression, with the respective roots of the adjacent blades. Pre-stressed contact with the side faces opposite the roots of the blades can be ensured as a result of such rounded edges.

To prevent the damping shims from creeping, a metal plate is attached to the outer face of each damping shim. Advantageously, the plate is overmoulded onto the damping shim.

Each damping shim can comprise, at the axial ends thereof, countersinks for receiving portions of members for fixing the shim to the disc.

The invention also relates to a twin-spool turboshaft engine comprising, from upstream to downstream in the gas flow direction, a fan, a compressor, a combustion chamber, a turbine and an exhaust nozzle.

Advantageously, the fan is as defined above.

The figures in the accompanying drawings will show how the invention can be implemented. In these figures, identical reference numerals denote like elements.

FIG. 1 is a schematic axial or longitudinal partial cross section of the front portion of a turboshaft engine having a fan and a low-pressure compressor, such as a bypass turbojet engine for an aircraft.

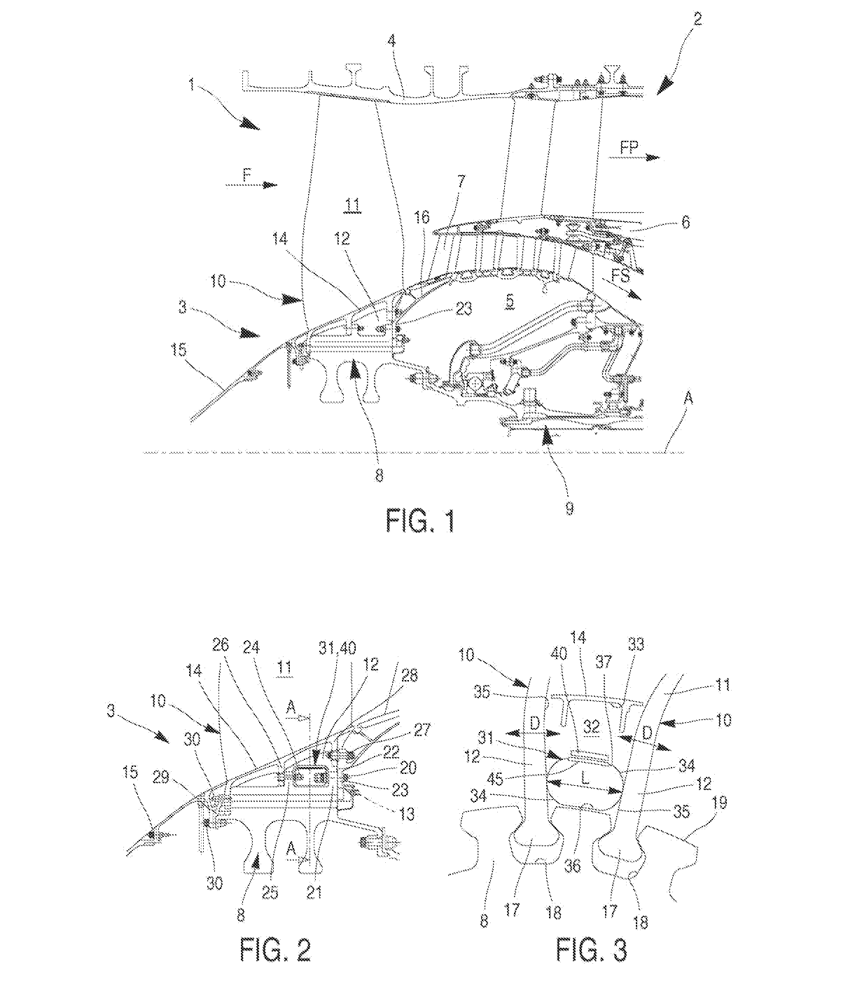

FIGS. 2 and 3 are, respectively, an enlarged view of the blade disc of the fan in FIG. 1 and a cross section along the line A-A in FIG. 2, showing the arrangement of one of the damping shims of the invention between two adjacent blades of the disc of the fan.

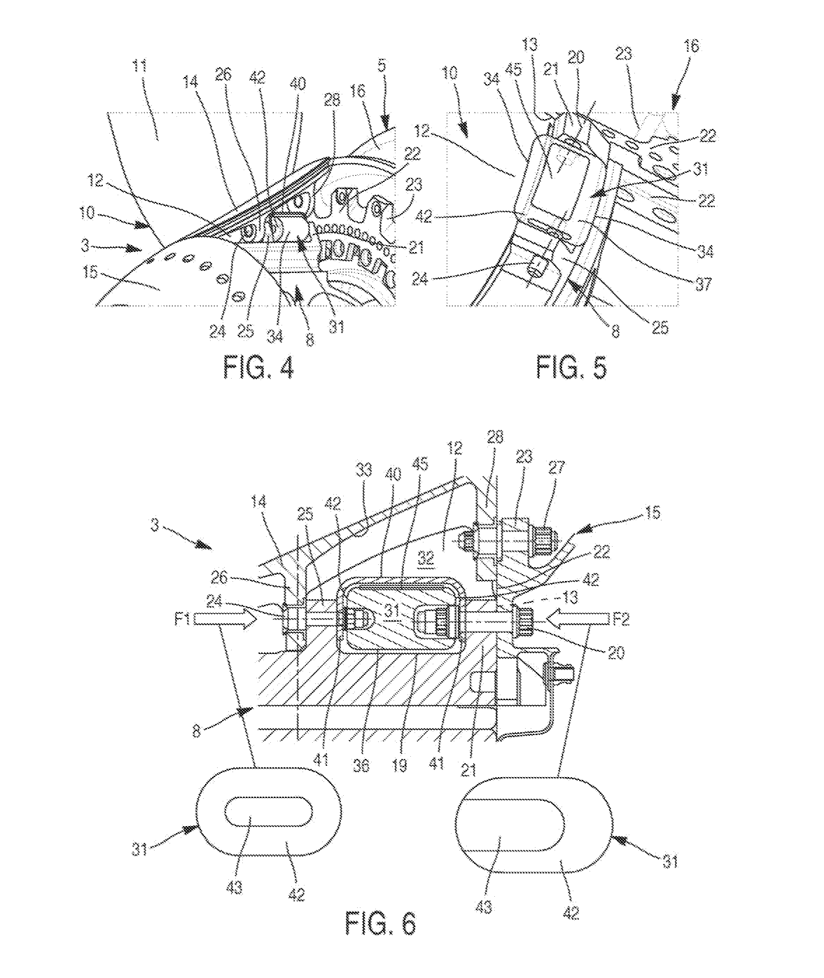

FIGS. 4 and 5 are partial cut-away perspective views of the fan disc in two different directions, showing the arrangement and fixing of one of the damping shims between the fan disc and the low-pressure compressor drum.

FIG. 6 is an enlarged view of how the damping shim is fixed in relation to both the fan disc and the compressor drum.

The front portion 1 of the bypass turbojet engine 2, shown in a partial view in FIG. 1, comprises, from upstream to downstream in the flow direction of the air flow F drawn in, in relation to the longitudinal axis A of the engine, a fan 3 housed in an external casing or nacelle 4, and a low-pressure compressor 5 which extends the fan so as to be constrained to rotate therewith. The compressor is surrounded by a fixed cylindrical spool 6 which separates the flow F into a primary flow FP with the nacelle and a secondary flow FS which passes through the blades 7 of the low-pressure compressor 5. Located in the rear portion of the compressor (and thus not shown in FIG. 1) are, in succession and in the usual manner, a high-pressure compressor, a combustion chamber, high- and low-pressure turbines and an exhaust nozzle.

With reference to FIGS. 1 and 2, the fan 3 mainly comprises a fan disc 8 which, during the taxiing and flying phases of the aeroplane, is rotated by a low-pressure shaft 9 driven by the low-pressure turbine, and a plurality of radial blades 10 which are carried by the disc and are distributed regularly relative to one another over the outer periphery 19 of the disc. Each radial blade 10 comprises a vane 11 in the flow F and a root 12.

In this type of engine, fan platforms 14 are inserted between the radial blades 10 and are attached to the fan to ensure, among other things, a continuous surface between a conical cowl 15, in which the upstream portion of the fan 3 terminates, and a drum or rotor 16 of the low-pressure compressor. These platforms 14 thus surround the disc 8 while being at a radial distance therefrom.

In particular, as shown in FIGS. 2 and 3, the vanes 11 are located radially on the outside of the platforms 14, while the roots 12 of the blades are located below the platforms. The roots 12 end in heels 17 intended for insertion into receiving recesses or grooves 18, which are made in parallel with the axis A of the disc and open on the outer periphery or surface 19 of the disc. These heels have a dovetailed or bulb shape in order to interact with the recesses in the manner of a tongue and groove connection.

The radial blades 10 can move in an angular manner relative to the recesses 18 in the radial plane of the fan, which movement is admittedly limited, less than 1 or 2°, and necessary for the assembly thereof.

In addition, the disc 8, the platforms 14 and the cowl 15 of the fan are rigidly connected to one another, and, with respect to the disc and the platforms, rigidly connected to the drum 16 of the compressor.

For this purpose, as shown in FIGS. 2 and 4-6, the fan disc 8 is fixed, on one side, to the drum 16 by means of first fixing members 20 (such as bolts) which join downstream external radial tabs 21 on the disc to the transverse face 22 of an upstream connecting flange 23 of the drum, the members 20 passing through coaxial holes provided in the tabs and the upstream flange. On the other hand, the disc 8 is connected to the platforms 14 by means of second fixing members 24 (such as fixing pins) which join external radial tabs 25 located in the central portion of the disc and on the periphery 19 of the disc to internal radial lugs 26 (or tabs) located in the central portion of the platforms 14. The members 24 are inserted into coaxial holes in the corresponding tabs and lugs.

The platforms 14, which in this case are attached to the disc and are not integral therewith, are also fixed to the upstream flange 23 of the drum by means of third fixing members 27 (bolts or the like). Internal radial lugs 28 downstream of the platforms are arranged so as to face the upstream flange in order to be fixed to said flange by means of the members 27 which are inserted into respective holes in the lugs and flange.

Lastly, the disc 8 and the platforms 14 are fixed upstream by an annular intermediate plate 29, downstream of or behind the conical cowl 15, by means of fixing members 30.

Advantageously, as shown in FIGS. 2 to 6, the fan 3 is equipped with damping shims 31, the intention behind which is to reduce and absorb as far as possible the angular movement of the blades 10 in their respective recesses 18, and, as a result, to limit or eliminate wear produced by rubbing as a result of the rear faces 13 of the roots 12 of the blades being in contact with the rear face 22 of the upstream connecting flange 23 of the drum when the fan 3 is windmilling (not driven by the drive shaft 9), for the reasons set out above.

For this purpose, the damping shims 31 are elastically deformable and arranged tangentially on the outer periphery 19 of the disc between the successive adjacent blades 10, thus being in contact therewith. In particular, as shown in FIGS. 3 to 6, the damping shims 31 are located in cavities 32 which are each defined by the outer surface or periphery 19 of the disc, the two roots 12 of the adjacent blades and the underside 33 of the attached platform 14. The damping shims are made of a polymer material such as an elastomer, for example a polyurethane, having a hardness of between 60 and 90 Shore, such as to have shims that have a certain flexibility while being sufficiently rigid in order to maintain a suitable mechanical strength.

It should also be noted that each damping shim 31 is located radially close to the outer surface 19 of the disc in order to absorb the angular movement of the blades as closely as possible to the connection of the heels 17 to the recesses 18.

For obvious reasons of balancing the fan, the damping shims 31 are arranged in the same radial plane as the disc and between all the radial blades 10 of the disc (so there are the same number of shims as blades), and they also all have identical dimensions. In this respect, in the non-limiting example shown, the damping shims 31 are cylindrical and flattened, in particular having a stadium-shaped oblong cross section. Any other shape is conceivable.

As can be seen in FIG. 3, the transverse width L of the shim shown, which corresponds to the tangential width once mounted on the periphery of the disc, between its two rounded edges 34 is at least equal to or greater than the width separating the opposing side faces 35 of the adjacent blades. Since the shims are made of an elastically deformable material, it can be ensured that the tangential contact with the blades is effective in absorbing as much of the angular movement as possible, as represented by arrows D in FIG. 3. The two rounded edges 34 of each shim 31 are thus compressed and bear on the opposing side faces 35 of the roots of the blades in question, while the lower straight portion 36 faces the outer surface 19 of the disc, which is close thereto, and the upper straight portion 37 faces the platform 14, which is remote therefrom. The damping shims 31 thus pressed are positioned tangentially between the roots of the blades.

In addition, in order to hold the damping shims 31 in a radial position and so as to be compressed between the roots of the radial blades, a support 40 is provided for each of the shims which receives the shim and is itself fixed to the disc 8 at its corresponding ends. As shown in FIGS. 4 and 6, the support 40 is housed in the inter-blade cavity 32 and is stirrup-shaped in the form of an upside down U, between the side legs 41 of which the shim 31 is inserted by its radial faces 42 which are perpendicular to the rounded edges 34. The legs 41 of the stirrup, which are also arranged radially with respect to the fan, are in turn advantageously inserted between the external radial tabs 21 and 25 of the disc 8.

The members 20 and 24 for fixing the disc to the drum and the disc to the platforms, respectively, are thus likewise used to fix the supports 40 for receiving the shims to the disc 8. For this purpose, there is no need for any structural modification of said disc or of other surrounding parts in order to fit the damping shims 31 with the supports 40 thereof. Said shims are thus confined in the supports so that their rounded edges 34 project tangentially from the stirrup-shaped supports 40 in order to come into contact with the faces 35 of the respective roots 12 of the adjacent blades 10. Furthermore, in order to absorb the centrifugal forces and ensure mechanical strength, the supports 40 for receiving and holding the shims are made of metal.

It can also be seen in FIGS. 5 and 6 and in the magnified views according to the arrows F1 and F2 in FIG. 6 that countersinks 43 are made in the radial faces 42 of the shims 31 in order to receive corresponding nuts of the fixing members 20, 24 and to simplify the assembly of the shims and of the supports between the radial tabs on the disc. The two countersinks 43 thus limit the axial clearances between each shim and its support, which ensures that the shims are in a constant and reliable position during repeated loading processes. Furthermore, the downstream countersink 43 according to the arrow F2 opens tangentially in order to assist the assembly of the shim. The two countersinks 43 have different geometric characteristics, which prevents errors in the assembly direction of the shims 31.

The curvilinear form of the attached platforms 14, which are separate from the blades, and the fact that the fixing members 20 and 24 of the disc are not coaxial can also be seen in FIGS. 4 and 5. In FIG. 6, the two members have been brought into the same plane.

To prevent the shims 31 from creeping during operation of the turbojet engine when in flight, and to do so despite the presence of the supports 40, a metal plate 45 is arranged on the outer surface or top surface 37 of each shim. This plate is overmoulded onto the shim so as to form just one single “shim-plate” assembly. In addition, a metal-metal contact is obtained between the plate and the support, which ensures optimum mechanical strength and a long service life of the elastically deformable damping shims.

It should thus be understood that, by means of the tangential contact of the elastically deformable damping shims 31 with the blades 10, said shims introduced tangentially between the roots of the blades allow for the angular movement of said blades to remain inside the recesses 18 thereof. As a result, the arrangement of the damping shims allows the relative sliding between the rear faces 13 of the roots 12 of the blades and the front face 22 of the upstream flange 23 of the drum and the resultant wear to be limited and eliminated when the fan 3 is windmilling. In addition, during operation of the turbojet engine, said shims thus arranged also help to absorb the vibrations of the vanes 11 of the blades when the fan 3 is being driven by the low-pressure shaft 9, in the manner of the known damping devices.

1. Fan for a multi-flow turboshaft engine, comprising a fan disc which is capable of being rotated about a longitudinal axis and which is provided, on the periphery thereof, with radial blades, each comprising a root which is slidably inserted into a groove in the disc, and, on the outside of said fan, a vane, attached platforms which surround the disc by being placed between the radial blades, and damping shims which are provided in respective cavities defined by the outer surface of the disc, the roots of the vanes, and the platform,
wherein the damping shims are arranged tangentially on the outer periphery of said disc, close to the outer surface thereof, between two roots of adjacent radial blades, are elastically deformable, and have a tangential width which is at least equal to the distance separating two adjacent blades on the periphery of the disc, each shim being mounted so as to be in tangential contact, as a result of compression, with the two adjacent blades, and a fixed support being provided in each cavity receiving a shim in order to radially hold said shim in position.

2. The fan according to claim 1, wherein the damping shims are provided between all the blades of the disc.

3. The fan according to claim 1, wherein each support is fixed on one side by a first fixing member which connects the disc to a connecting flange of a compressor drum, and on the other side by a second fixing member which connects the disc to the platform.

4. The fan according to claim 3, wherein said support is stirrup-shaped in the form of an upside down U, between the legs of which the damping shim is arranged and which is inserted between two external radial tabs on the disc, which interact with a central radial lug on the corresponding platform and the flange, respectively, said damping shim projecting tangentially from said U-shaped support in order to be in contact with the two roots of adjacent blades.

5. The fan according to claim 1, wherein each damping shim has an oblong, elliptical or similar shape, having rounded opposite side edges which come into contact, as a result of compression, with the respective roots of the adjacent blades.

6. The fan according to claim 1, wherein a metal plate is attached to an outer face of each damping shim.

7. The fan according to claim 6, wherein the plate is overmoulded onto the damping shim.

8. The fan according to claim 1, wherein the damping shims are made of a synthetic or natural polymer material, such as an elastomer.

9. The fan according to claim 8, wherein the material of the shims has a hardness in a range of from 60 to 90 Shore.

10. Twin-spool turboshaft engine comprising, from upstream to downstream in the gas flow direction, a fan, a compressor, a combustion chamber, a turbine and an exhaust nozzle, wherein the engine further comprises the fan according to claim 1.
